(19) United States
(12) Patent Application Publication
(10) Pub. No.: US 2019/0077390 A1
(43) Pub. Date: Mar. 14, 2019

(54) ENERGY BASED PARK BRAKE END OF LIFE DETECTION SYSTEM AND METHOD

(71) Applicant: CNH Industrial America LLC, New Holland, PA (US)

(72) Inventors: Kushan Vora, Westmont, IL (US); Brian Hartman, Valparaiso, IN (US); Haibo Guo, Naperville, IL (US)

(73) Assignee: CNH Industrial America LLC, New Holland, PA (US)

(21) Appl. No.: 15/703,005

(22) Filed: Sep. 13, 2017

(51) Int. Cl. B60T 17/22; G01P 3/44; G01L 3/00; G01L 5/28; F16D 66/02

(52) U.S. Cl. CPC B60T 17/221; G01P 3/44; F16D 2066/003; G01L 5/28; F16D 66/021; G01L 3/00

(57) ABSTRACT

A vehicle including a shaft, a park brake connected to the shaft and configured to retard a rotation of the shaft, and a park brake prognosis system associated with the shaft and the park brake. The park brake prognosis system includes a controller that is configured to calculate a status of the park brake dependent on a park brake energy of at least one engagement of the park brake and a first sensor operably coupled to the controller and the shaft. The first sensor is configured to provide a speed of the shaft. The park brake prognosis system also includes a second sensor operably coupled to the controller and the shaft. The second sensor is configured to provide an instantaneous torque of the shaft.

### FIELD OF THE INVENTION

The present invention pertains to work vehicles and, more specifically, to work vehicles that include a park brake.

### BACKGROUND OF THE INVENTION

Typically, work vehicles include a service brake system as well as a park brake system. The park brake may be used in isolation to hold the vehicle at rest in a parked position, or the park brake may be used as a secondary brake in conjunction with the primary service brakes in a situation in which the vehicle needs to stop in a quick or abrupt manner. The park brake may be incorporated into the mechanical transmission of the vehicle. For instance, the park brake may be provided at some location within the power train of the work vehicle, which connects the rotational output of the vehicle's power unit to the drive wheels. Generally, a park brake will include two sets of annular friction plates and an actuator to force the respective plates together in order to retard the movement of a torque-carrying power shaft. The first set of annular friction plates, for example steel plates, may be fixed to the park brake housing such that the first set of plates may move axially but are rotationally fixed. The second set of annular friction plates may be coupled to the torque-carrying power shaft such that the second set of plates rotate along with the shaft. In this regard, the friction between the plates slows the rotation of the power shaft. The plates may be submersed in a lubricant within the park brake housing.

Overtime the secondary brake may become worn or damaged. Generally, the park brake as a secondary brake can only be engaged for a finite number of times to stop a moving vehicle. For example, the application of the secondary brake at a high speed and/or at a high vehicle load can generate heat and cause wear which may damage the park brake. As can be appreciated, it can be advantageous to regularly service and/or replace the secondary brake. For example, vehicle functions may degrade if the secondary brake is worn or damaged. However, an operator or a dealer may not be aware of the condition of the secondary brake.

What is needed in the art is a system and method for estimating the life of a secondary brake.

### SUMMARY OF THE INVENTION

The present invention provides a system and method for calculating the park brake energy, determining the remaining life of the park brake, and informing an individual of the remaining life of the park brake. The present invention also can inform an individual how much the park brake has been damaged.

The invention in one form is directed to a vehicle including a shaft, a park brake connected to the shaft and configured to retard a rotation of the shaft, and a park brake prognosis system associated with the shaft and the park brake. The park brake prognosis system includes a controller that is configured to calculate a status of the park brake dependent on a park brake energy of at least one engagement of the park brake and a first sensor operably coupled to the controller and the shaft. The first sensor is configured to provide a speed of the shaft. The park brake prognosis system also includes a second sensor operably coupled to the controller and the shaft. The second sensor is configured to provide an instantaneous torque of the shaft.

The invention in another form is directed to a method for estimating a park brake life of a park brake which retards a shaft of a vehicle. The method includes the steps of providing a park brake prognosis system. The park brake prognosis system includes a controller that is configured to calculate a status of the park brake, a first sensor operably coupled to the controller and the shaft, the first sensor is configured to provide a speed of the shaft, and a second sensor operably coupled to the controller and the shaft. The second sensor is configured to provide an instantaneous torque of the shaft. The method includes the further steps of calculating a park brake energy of at least one engagement of the park brake, and calculating the park brake life status dependent on the park brake energy.

The invention in yet another form is directed to a method for estimating a park brake life of a park brake which retards a shaft of a vehicle. The method includes the steps of providing a park brake prognosis system. The park brake prognosis system includes a controller that is configured to calculate a status of the park brake, a first sensor operably coupled to the controller and the shaft, the first sensor is configured to provide a speed of the shaft, and a second sensor operably coupled to the controller and the shaft. The second sensor is configured to provide an instantaneous torque of the shaft. The method includes the further steps of determining by the controller whether the park brake is engaged, calculating by the controller a park brake energy of an engagement of the park brake, calculating by the controller a remaining brake life number dependent on the park brake energy, and determining by the controller whether the remaining brake life number is greater than zero. The method further includes one of repeating the steps of determining whether the park brake is engaged, calculating the park brake energy, calculating the remaining brake life number, and determining whether the remaining brake life number is greater than zero dependent upon the remaining brake life number being greater than zero, or notifying an individual of the status calculated by the controller dependent upon the remaining brake life number not being greater than zero.

An advantage of the present invention is that an individual may be notified of the wear and/or damage of a park brake of a vehicle.

Another advantage of the present invention is that the remaining life of a park brake may be cost-effectively and efficiently calculated as a function of the park brake energy.

### BRIEF DESCRIPTION OF THE DRAWINGS

For the purpose of illustration, there is shown in the drawings a certain embodiment of the present invention. It should be understood, however, that the invention is not limited to the precise arrangements, dimensions, and instruments shown. Like numerals indicate like elements throughout the drawings. In the drawings:

FIG. 1 is a schematic illustration of an exemplary embodiment of a system to estimate the wear to a park brake in accordance with an exemplary embodiment of the present invention;

FIG. 2 illustrates a graph of the number of engagements a park brake may take at a particular energy level in accordance with an exemplary embodiment of the present invention; and

FIG. 3 illustrates a flowchart of a method for estimating the wear of a park brake in accordance with an exemplary embodiment of the present invention; and

FIG. 4 illustrates a flowchart of another method for estimating the wear of a park brake in accordance with an exemplary embodiment of the present invention.

Corresponding reference characters indicate corresponding parts throughout the several views. The exemplification set out herein illustrates an embodiment, in one form, of the invention and such exemplification is not to be construed as limiting the scope of the invention in any manner.

### DETAILED DESCRIPTION OF THE INVENTION

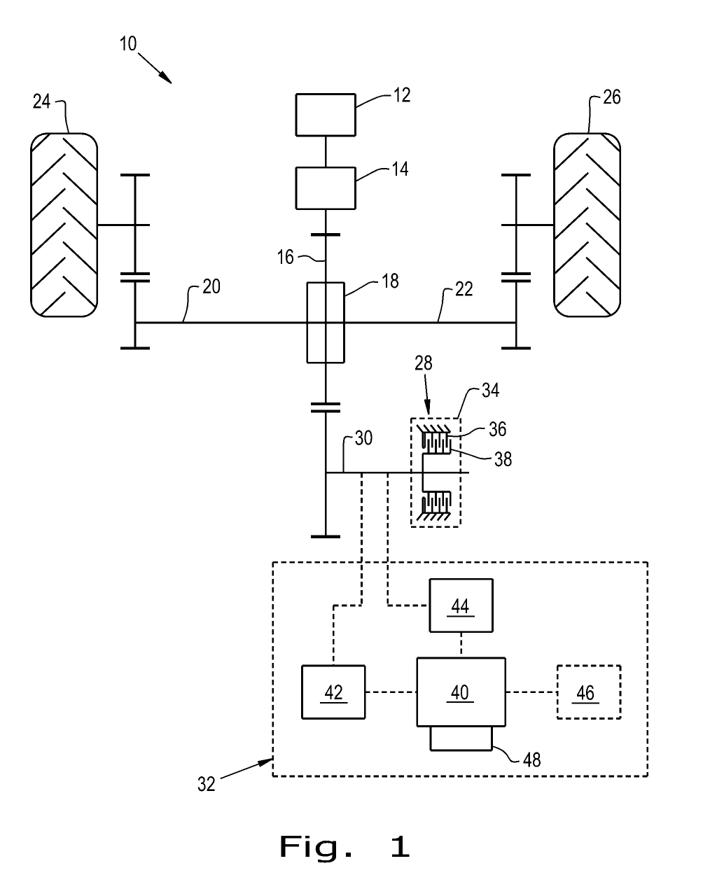

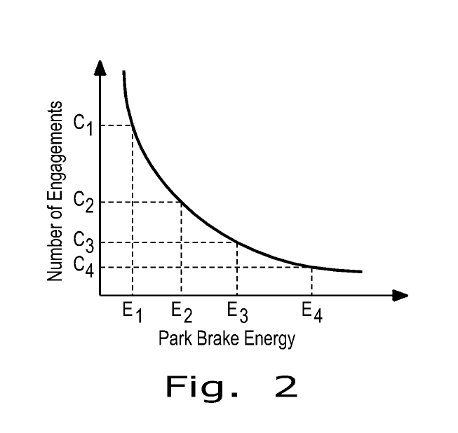

Referring now to the drawings, and more particularly to FIGS. 1-2, there is shown a schematic representation of a portion of a vehicle 10 which generally includes an engine 12 that is mechanically interconnected to a transmission 14 and an input shaft 16. The input shaft 16 extends to a differential 18, which respectively powers left and right shafts 20, 22. In turn, the shafts 20, 22 respectively power the movement of the wheels 24, 26. The vehicle 10 may also include a park brake 28, which is coupled to a park brake shaft 30, and a park brake prognosis system 32.

The park brake 28 may include a park brake housing 34, two sets of annular friction plates 36, 38, and an actuator (not shown) which forces the plates 36, 38 to contact one another. The first set of friction plates 36 may be axially moveable but rotationally fixed relative to the park brake housing 34. The second set of friction plates 38 may be coupled to the park brake shaft 30 such that the friction plates 38 rotate along with the shaft 30. The friction plates 36, 38 may be composed of any desired material such that they provide a sufficient friction force to retard the motion of the park brake shaft 30. Additionally, the friction plates 36, 38 may be submersed in a lubricant within the park brake housing 34. It is noted that a park brake engagement may be defined as retarding of the shaft 30, for example, from an initial time when the friction plates 36, 38 first engage with each other till a time when the shaft 30 is completely stopped.

The park brake prognosis system 32 may include a controller 40, one or more speed sensor(s) 42, one or more sensor(s) 44 configured to provide a torque of the shaft 30, and an indicator 46. The park brake prognosis system 32 is configured to calculate the park brake energy, determine a status of the park brake life, or a percent thereof, and inform an operator and/or a dealer of the status of the park brake life so that the park brake may be serviced and/or replaced. The park brake prognosis system 32 determines the remaining park brake life dependent on the park brake energy.

The controller 40 is configured to calculate a status of the park brake 28. The controller 40 may be located on the work vehicle 10 and/or incorporated into the existing control system of the work vehicle 10. The controller 40 may be in the form of a CPU, an ECU, or a processor. The controller 40 may also include a memory 48, which may be preloaded with certain parameters pertaining to the operation of a particular type of park brake. For example, the memory 48 may include a set of values corresponding to the maximum number of engagements that a particular park brake 28 may be desirably used for until service and/or replacement of the park brake 28 is desired. Additionally, the memory 48 may include a set of predetermined values corresponding to any desired or a maximum number of engagements that the park brake 28 may be able to take without getting damaged at a specified park brake energy level.

The speed sensor 42 and the torque sensor 44 may be operably coupled to the controller 40 as well as to the park brake shaft 30. The speed sensor 42 is configured to provide the speed of the brake shaft 30, and the torque sensor 44 is configured to provide the instantaneous torque acting on the brake shaft 30. Either sensor 42, 44 may communicate to the controller 40 via a wired or wireless connection. The speed sensor 42 may be in the form of a known speed sensor, for example, a magnetic speed sensor that couples to the shaft 30 and monitors the speed of the shaft 30. The torque sensor 44 may be in the form of a non-contact sensor or a contact sensor which couples to the shaft 30. For example, the torque sensor 44 may be in the form of a strain gauge or a clamp-on torque cell. Additionally, the sensor 44 may be in the form of a pressure or tracer sensor 44, which is used to calculate the torque of the shaft 30. Thereby, for example, the brake torque information may be obtained by measuring the brake pressure, and then the controller 40 may calculate the instantons brake torque.

The indicator 46 may be operably coupled to the controller 40 and may be configured for notifying an individual, such as an operator or dealer, of the status that is calculated by the controller 40. The indicator 46 may be located within the work vehicle 10. For example, the indicator 46 may be in the form of a visual indicator, such as an indicator light located within the cab of the work vehicle 10. Additionally, the indicator 46 may be integrated as part of a display unit which has a graphic or a display that informs the operator that the park brake 28 should be serviced and/or replaced. Alternatively, the indicator 46 may be located away from the work vehicle 10 such that a dealer of the work vehicle 10 may be notified of the need to replace the park brake 28. For example, an individual, e.g., a dealer, may be wirelessly notified of the status of the park brake 28.

The controller 40 may calculate the total park brake energy for a given engagement (i.e. application) of the park brake 28, as shown in the algorithm below. For example, the controller 40 may calculate the park brake energy over an engagement period which spans from an initial time when the plates 36, 38 first contact each other till the time at which the park brake shaft 30 completely stops rotating. Thereby, the total energy during one park brake application can be calculated as:

E_{pb}=∫₀^{T}τ_{pb}(t)·ω(t)dt

The total park brake energy of a single engagement of the park brake 28 is accumulated from the time the park brake 28 is initially engaged, e.g. t=0, until the time the brake shaft 30 stops rotating. E_{pb} is the total amount of park brake slippage energy generated during one park brake application. τ_{pb} (t) is the instantaneous park brake torque which may be provided by the torque sensor 44. ω(t) is the park brake shaft speed which may be provided by the speed sensor 42.

The controller 40 may then determine the remaining brake life number (RBLN) which is dependent on the park brake energy during one or more engagement(s) as calculated above. The controller 40 may then report the status of the park brake 28 if the RBLN approaches a predetermined value. For example, a park brake end of life warning status may be reported when the RBLN value approaches zero, is zero, or falls below zero. With reference to FIG. 2, the following examples illustrate the determination of the RBLN according to the algorithm of the controller 40 of the present invention. It is noted that FIG. 2 illustrates a graphical representation of the approximate number of engagements C₁, C₂, C₃, C₄ that the park brake 28 may take at a respective specified energy level E₁, E₂, E₃, E₄ until service and/or replacement of the park brake 28 is desired. It should be appreciated that the number of engagements may be predetermined values based on characteristics of a particular park brake, such as the park brake model, the material of the friction discs, etc. The curve illustrated in FIG. 2 is for exemplary purposes only.

If the total accumulated energy during a first park brake engagement is E₃, then the brake life deterioration number (BLDN) is calculated as:

$$BLDN = \frac{{C}_{4}}{{C}_{3}}$$

If the total accumulated energy during a second park brake engagement is E₂, then the accumulated BLDN is calculated as:

$$BLDN = \frac{{C}_{4}}{{C}_{3}} + \frac{{C}_{4}}{{C}_{2}}$$

If energy during a third park brake engagement is less than E₁, then the BLDN does not change from the second park brake engagement because no damage is generally done to the park brake 28 at an energy level which is less than E₁.

As BLDN increases, RBLN reduces as depicted below:

RBLN=BLDNThreshold−BLDN

The BLDNThreshold may be defined as C₄ (e.g. the threshold engagement number at a specified energy level). Thereby, the RBLN may be equal to the value of C₄ subtracted by the summation of the number of engagements at distinct energy levels for each individual engagement of the park brake 28 as it is used over the course of its operational life. In other words, the RBLN may be based on the park brake energy E₁, E₂, E₃, E₄ and the number of engagements C₁, C₂, C₃, C₄. The memory 48 may include the values of the predetermined maximum number of engagements C₁, C₂, C₃, C₄, C_{N} that the park brake 28 can take at a given park brake energy level E₁, E₂, E₃, E₄, E_{N} until service and/or replacement is desired (FIG. 2). Once RBLN approaches zero or is approximately zero, the controller 40 may report the park brake near end of life warning to an individual via the indicator 46. It should be appreciated that the park brake near end of life warning may be an indication to service and/or replace the park brake 28. The park brake life in percentage can be calculated by further dividing the RBLN number by BLDNThreshold and multiplying it by one hundred.

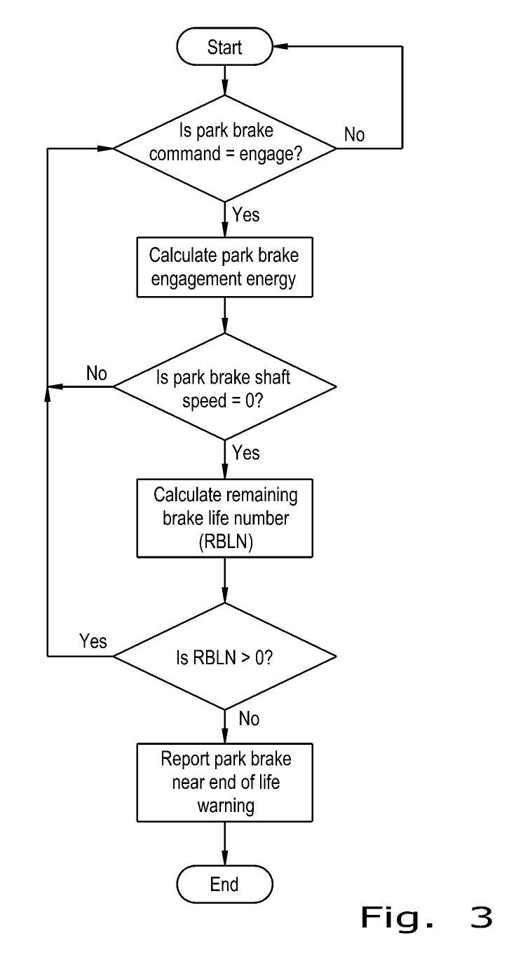

Referring now to FIG. 3, there is shown a method for operating the park brake prognosis system 32. The method may begin by determining whether the park brake command is on, i.e., whether the park brake 28 is engaged. However, the step of determining whether the park brake command is engaged may not be obligatory; for example, the park brake prognosis system 32 may be automatically initiated upon engaging the park brake 28. Once the park brake 28 is engaged, the controller 40 via the algorithm discussed above may calculate the park brake engagement energy. The controller 40 may simultaneously determine whether the speed of the park brake shaft 30 is zero. If the speed of the brake shaft 30 is not zero, then the controller 40 may continue to calculate the park brake engagement energy. If the speed of the brake shaft 30 is zero, then the controller 40 may calculate the remaining brake life number (RBLN) using the algorithm as discussed above. The controller 40 may then determine whether the RBLN is close to or at a predetermined value. For example, the controller 40 may determine whether the RBLN is greater than zero. If the RBLN is greater than zero, then the park brake prognosis system 32 may loop back to its beginning step and repeat the process. However, if the calculated RBLN is approximately, equal to, or less than zero, then the controller 40 may notify an individual. For instance, the controller 40 may send a status signal to the indicator 46, which may report a status to an individual to service and/or replace the park brake 28. The status may be, for example, a park brake near end of life status, a park brake remaining life status, and/or a park brake how much is used status. Additionally, the status may be an estimated percentage of the used and/or remaining life of the park brake 28.

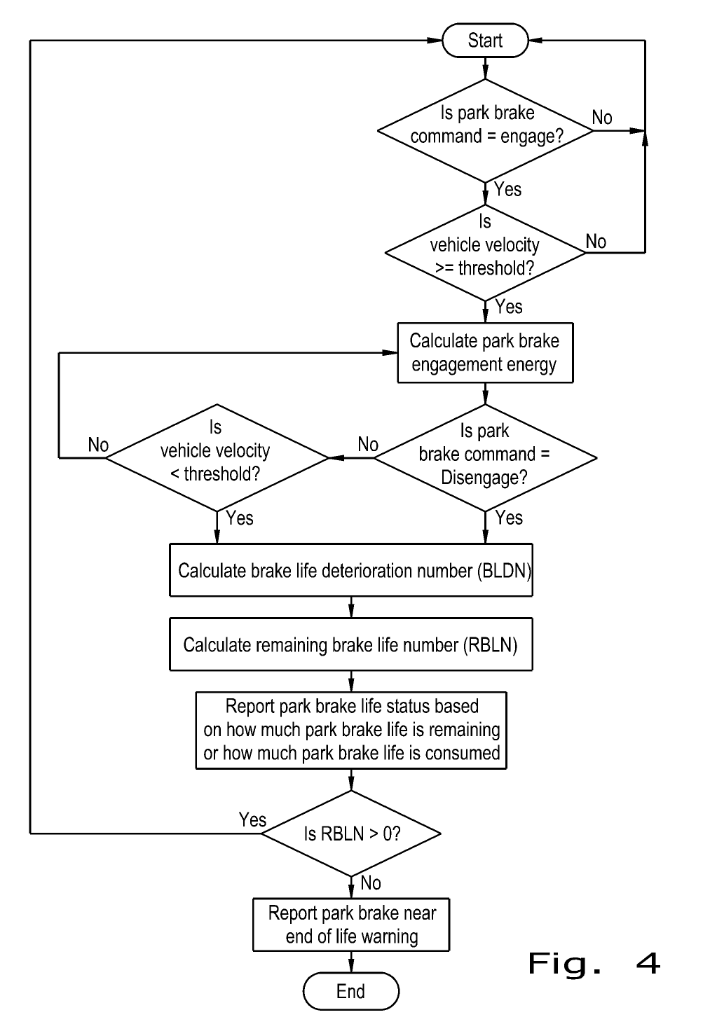

Referring now to FIG. 4, there is shown another method for operating the park brake prognosis system 32. The method may initially determine whether the park brake command is engaged. The method may further determine whether the vehicle velocity is greater than or equal to a threshold velocity value. The park brake engagement energy may then be calculated as discussed above, and the method may then determine whether the park brake command is disengaged and/or whether the vehicle velocity is lower than the specified threshold value. The method may calculate the park brake energy based BLDN depending upon the aforementioned conditions. The method may calculate the RBLN after determining the BLDN. The method may report the park brake life status, which is based on how much park brake life is remaining and/or how much park brake life is consumed. The method may determine whether the RBLN is greater than zero, and depending upon the RBLN, the method may continue to loop back to the beginning step and repeat the process, or it may report the park brake near end of life warning to an individual as discussed above.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A vehicle, comprising:
a shaft;
a park brake connected to the shaft and configured to retard a rotation of the shaft; and
a park brake prognosis system associated with the shaft and the park brake, including:
a controller configured to calculate a status of said park brake dependent on a park brake energy of at least one engagement of said park brake;
a first sensor operably coupled to the controller and the shaft, said first sensor configured to provide a speed of the shaft; and
a second sensor operably coupled to the controller and the shaft, said second sensor configured to provide an instantaneous torque of the shaft.

2. The vehicle of claim 1, further including an indicator operably coupled to the controller and configured for notifying an individual of said status calculated by the controller.

3. The vehicle of claim 1, wherein said park brake energy is a function of the speed of the shaft and the instantaneous torque of the shaft.

4. The vehicle of claim 1, wherein said status is a park brake near end of life status.

5. The vehicle of claim 2, wherein said controller further includes a memory.

6. The vehicle of claim 5, wherein said memory includes a set of predetermined values corresponding to a maximum number of engagements that said park brake may be able to take without getting damaged at a specified park brake energy level.

7. The vehicle of claim 6, wherein said status is based on a remaining brake life number which is dependent on said park brake energy of the engagement of said park brake and said maximum number of engagements that said park brake may be able to take without getting damaged.

8. The vehicle of claim 7, wherein said first sensor is in the form of a speed sensor and said second sensor is in the form of at least one of a pressure sensor, a tracer sensor, and a torque sensor.

9. A method for estimating a park brake life of a park brake which retards a shaft of a vehicle, comprising the steps of:
providing a park brake prognosis system, including a controller configured to calculate a status of said park brake, a first sensor operably coupled to the controller and the shaft, said first sensor configured to provide a speed of the shaft, and a second sensor operably coupled to the controller and the shaft, said second sensor configured to provide an instantaneous torque of the shaft;
calculating a park brake energy of at least one engagement of said park brake; and
calculating said status dependent on said park brake energy.

10. The method according to claim 9, wherein said status is at least one of a park brake near end of life status, a park brake remaining life status, and a park brake how much is used status.

11. The method according to claim 9, wherein said brake prognosis system further includes an indicator operably coupled to the controller, and said method including a further step of notifying an individual of said status by said indicator.

12. The method according to claim 9, wherein said park brake energy is a function of the speed of the shaft and the instantaneous torque of the shaft.

13. The method according to claim 9, wherein said controller further includes a memory.

14. The method according to claim 13, wherein said memory includes a set of predetermined values corresponding to a number of engagements that said park brake may take at a specified park brake energy level.

15. The method according to claim 14, the method including a further step of calculating by said controller a remaining brake life number which is dependent on said park brake energy and said number of engagements.

16. A method for estimating a park brake life of a park brake which retards a shaft of a vehicle, comprising the steps of:
providing a park brake prognosis system, including a controller configured to calculate a status of said park brake, a first sensor operably coupled to the controller and the shaft, said first sensor configured to provide a speed of the shaft, and a second sensor operably coupled to the controller and the shaft, said second sensor configured to provide an instantaneous torque of the shaft;
determining by said controller whether said park brake is engaged;
calculating a park brake energy of an engagement of said park brake;
calculating by said controller a remaining brake life number dependent on said park brake energy;
determining by said controller whether said remaining brake life number is greater than zero; and
one of:
repeating the steps of determining whether said park brake is engaged, calculating said park brake energy, calculating said remaining brake life number, and determining whether said remaining brake life number is greater than zero dependent upon said remaining brake life number being greater than zero; or
notifying an individual of said status calculated by said controller dependent upon said remaining brake life number not being greater than zero.

17. The method according to claim 16, wherein said park brake energy is a function of the speed of the shaft and the instantaneous torque of the shaft.

18. The method according to claim 16, wherein said controller further includes a memory including a set of predetermined values corresponding to a number of engagements that said park brake may take at a specified park brake energy level.

19. The method according to claim 18, wherein said method includes an additional step prior to said step of calculating said remaining brake life number, said additional step including calculating a brake life deterioration number dependent on said number of engagements and said park brake energy calculated by the controller.

20. The method according to claim 19, wherein said remaining brake life number is dependent on said brake life deterioration number.
